(19) United States
(12) Patent Application Publication
(10) Pub. No.: US 2015/0225103 A1
(43) Pub. Date: Aug. 13, 2015

(54) APPLICATOR FOR A ROLLED STRIP

(71) Applicant: Hsiu-Man YU CHEN, Taichung (TW)

(72) Inventor: Hsiu-Man YU CHEN, Taichung (TW)

(21) Appl. No.: 14/696,579

(22) Filed: Apr. 27, 2015

Related U.S. Application Data
(63) Continuation-in-part of application No. 13/330,930, filed on Dec. 20, 2011.

(51) Int. Cl. B65B 67/08; B25G 3/20; B65H 37/00

(52) U.S. Cl. CPC B65B 67/08; B65H 37/00; B25G 3/20

(57) ABSTRACT

An applicator for a rolled strip includes a grip, a lining and a pivotal tube. The grip is made of flexible material, formed in a tubular shape with a sealed bottom end and an open top end. The lining is inserted in the grip, also formed in a tubular shape with two open ends. The lining has a plurality of axial slots. The pivotal tube has one end to be inserted in the lining and another end to be inserted in an axial hole of a rolled strip. The pivotal tube can pivotally turn in the lining if not interfered by any external force. When a user holds the grip and applies a radial force against the grip, the pivotal tube will be squeezed by the lining to stop rotation so that the user can adjust the wrapping tightness of the rolled strip.

This application is a continuation-in-part of U.S. patent application Ser. No. 13/330,930 filed on Dec. 20, 2011.

### BACKGROUND OF THE INVENTION

1. Field of the Invention

This invention relates to an applicator for a rolled strip and particularly to one for applying a film roll.

2. Brief Description of the Prior Art

In general, in order to keep a commodity piled on a pellet from shaking to fall down during transportation, a wrapping material, such as plastic film, is used to wrap up such goods. The wrapping material is usually stored as a roll and will be applied to the goods with an applicator by an operator. FIG. 1 shows a conventional film applicator, invented by the present inventor, capable in adjusting the packing tightness of the wrapping material. The conventional film applicator includes a base body 1 which is formed in a cylindrical shape, a restriction groove 2 formed as a recess at the center portion of the base body 1, a grip 3 formed extending from one side of the restriction groove 2 of the base body 1, and an applicator 4 formed extending from another side of the restriction groove 2 of the base body 1 to be inserted in a central hole of a rolled film 5. Mounted around the restriction groove 2, there is provided a restriction member 6 which is composed of two semi-annular parts. A braking sleeve 7 is formed outside the restriction groove 2 and the grip 3. There are a plurality of braking strips 8 formed on the outer peripheral surface of the grip 3. When user holds the braking sleeve 7 and apply a radial force against the braking strip 8 on the grip 3, the friction between the braking sleeve 7 and the braking strip 8 will be increased so that to control the rotation of the applicator 4 for a proper application of the film. In another words, the rolled film 5 will be applied on the goods with an appropriate wrapping tension.

Although the conventional film applicator as described as above can properly adjust wrapping tightness of a rolled film 5, the overall structure of the applicator is still rather complicated to have a base body 1 recessed with a restriction groove 2 mounted with a restriction member 6 and the applicator 4 of the base body 1 to be pivotally inserted in a central hole of a film roll.

### SUMMARY OF THE INVENTION

The principle object of this invention is to provide an applicator for a rolled strip with a low cost of manufacturing, a simple structure and conveniently to be operated.

A principle advantage of the applicator for a rolled strip according to the present invention is the rolled strip can be easily ceased unreeling for a user to adjust tightness of the strip to pack goods effectively.

Another object of the present invention is to provide an applicator for a rolled strip with positioning members on the respective grip and lining to be tightly fitted with each other so that the lining will be firmly positioned in the grip.

Still another object of the present invention is to provide an applicator for a rolled strip which comprises a grip made of flexible material to be deformed slightly while a proper radial force has been applied to stop the rotation of the lining and in turn the pivotal tube.

A further object of the present invention is to provide an applicator for a rolled strip comprises restriction members on the lining and the pivotal tube so that they can be fixed together firmly.

In summary, the applicator for a rolled strip according to the present invention comprises a grip, a lining and a pivotal tube. The grip is made of flexible material, formed in a tubular shape with a sealed bottom end and an open top end. The lining is inserted in the grip, also formed in a tubular shape with two open ends. The lining is provided with two projections to correspondingly engage with the grooves of the grip, plural slots cut axially and at least an annular projection formed in an inner wall. The pivotal tube has one end inserted in an axial hole of a rolled strip and another end inserted in the lining, provided with an annular groove to correspondingly engage with the annular projection of the lining. The pivotal tube has an outer diameter slightly smaller than the inner diameter of the lining.

A user can hold the grip to enable the pivotal tube to rotate so as to wrap up goods with the rolled strip. With a radial force given by a user to make the lining compact the pivotal tube, the pivotal tube and the rolled strip can be stopped rotating to let the user to adjust packing tightness of the strip.

### BRIEF DESCRIPTION OF DRAWINGS

Other advantages, objectives and features of the applicator of a rolled strip according to the present invention will be better understood from the detailed description of the preferred embodiment with reference to the accompanying drawings, wherein:

FIG. 1 is a cross-sectional view of a conventional film applicator;

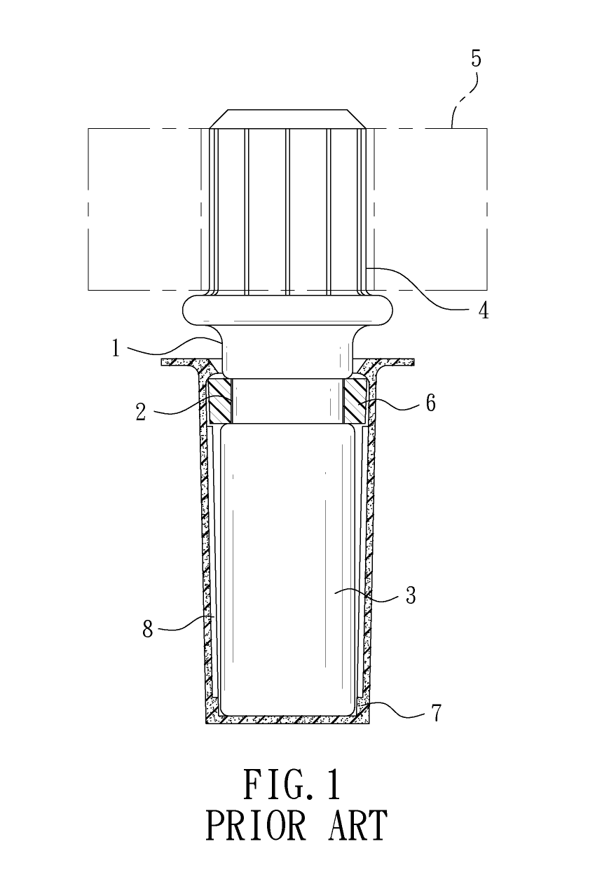

FIG. 2 is an exploded perspective view of a preferred embodiment of an applicator for a rolled strip according to the present invention;

FIG. 3 is an axially cross-sectional view of a grip in the preferred embodiment of an applicator for a rolled strip according to the present invention;

FIG. 4 is a sectional view of the grip along line ‘A-A’ in FIG. 3;

FIG. 5 is an axially cross-sectional view of a lining in the preferred embodiment for an applicator of a rolled strip according to the present invention;

FIG. 6 is a top view of the lining in the preferred embodiment for an applicator of a rolled strip according to the present invention;

FIG. 7 is a vertical sectional view of the preferred embodiment of an applicator for a rolled strip according to the present invention, showing it is operated normally; and

FIG. 8 is a vertical sectional view of the preferred embodiment of an applicator for a rolled strip according to the present invention, showing it is temporarily ceased operation while user applied a radial force in a direction as shown as the arrows B.

FIG. 9 is a sectional view of the present invention along line ‘C-C’ in FIG. 7;

### DETAILED DESCRIPTION OF THE PREFERRED EMBODIMENT

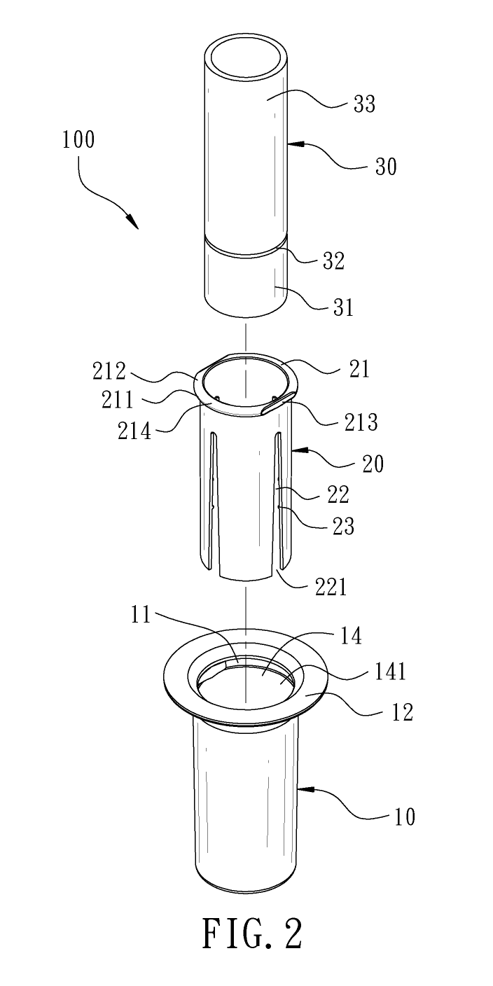

Referring to FIG. 2, a preferred embodiment of an applicator 100 for a rolled strip in the present invention includes a grip 10, a lining 20 and a pivotal tube 30.

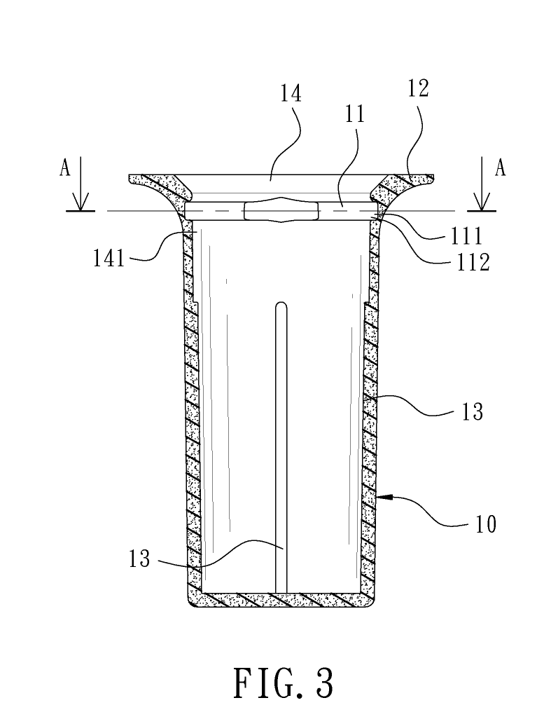

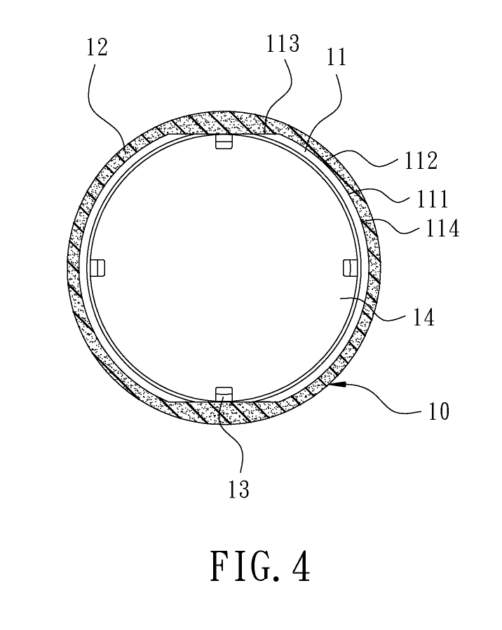

With reference to FIGS. 2 to 4, the grip 10 is made of flexible material, formed in a tubular shape with a sealed bottom end and an open top end. The grip 10 has an open end 14 with a first arced surface 141 having a first positioning member 11 formed thereon. The first positioning member 11 is a non circular member having a first inner peripheral surface 111. On the first inner peripheral surface 111, there are formed a plurality of first surfaces 112. The first surface 112 according to the present embodiment includes a first plan surface 113 and a first arced surface 114. The grip 10 has a flange 12 horizontally extended outwardly from the top so that user's hand will not contact with the rolled strip. There are a plurality of ribs 13 axially projected from the interior wall of the grip and spaced apart with equal spaced distance. In the embodiment, the first positioning member 11 has two ribs 13.

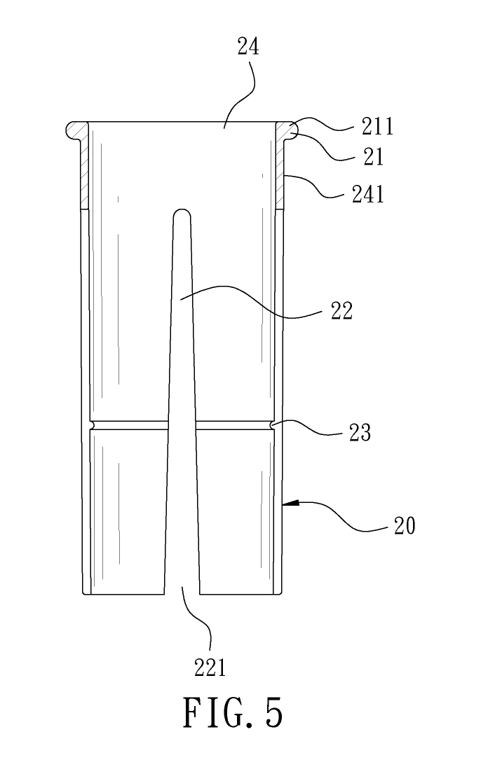

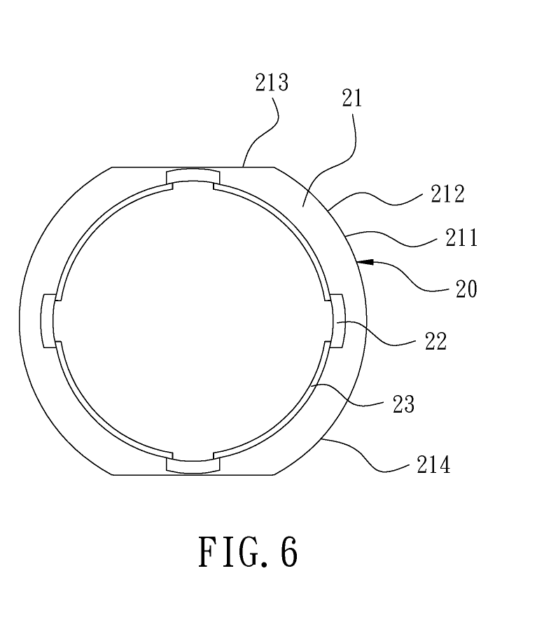

As shown in FIGS. 2, 5 and 6, the lining 20 is formed in a tubular shape with two open ends 24 and 221, and is inserted in the grip 10. A second positioning member 21 is formed at an outer peripheral surface 241 of the top end 24 of the lining 20. This second positioning member 21 is a non-circular member having a second outer peripheral surface 211. On the second outer peripheral surface 211, there are formed a plurality of second surfaces 212. The second surface 212 according to the present embodiment includes a second plan surface 213 and a second arced surface 214. The circular length of the second outer peripheral surface 211 of the second positioning member 21 is greater than the circular length of the first inner peripheral surface 111 of the grip 10. The second positioning member 21 of the lining 20 is formed on the outer wall to fit with the first positioning member 11. There are a plurality of slots 22 axially cut to be coincide with the ribs 13 of the grip 10. Each slot 22 has a free end 221. A restriction member 23 projected around the inner wall. In the embodiment, the second positioning member 21 is shaped as two semi-circular projections employed to make the grip 10 fixedly engaged with the lining 20. Each of the slots 22 has a free bottom end 221, and the first restriction member 23 is an annular projection protruding inwardly to the inside of the lining 20.

As shown in FIG. 2, the pivotal tube 30 has one end formed as a grip portion 31, a second restriction member 32 formed in the inner wall to be coincide with the first restriction member 23 of the lining 20. Another end of the pivotal tube 30 is formed into a tubular working member 33 which is plug in a rolled strip. In the embodiment, the second restriction member 32 is an annular groove to be fitted with the first restriction member 23. And the pivotal tube 30 has an outer diameter slightly smaller than the inner diameter of the lining 20 so that the pivotal tube 30 can rotate in the lining 20.

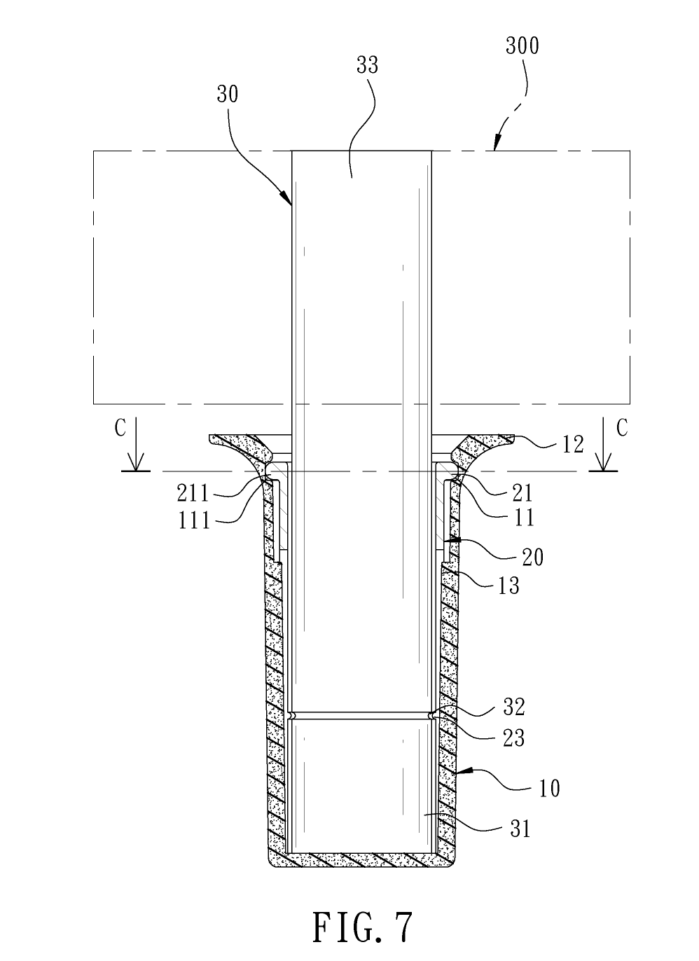

For assembly, as shown in FIG. 7, the bottom end of the lining 20 is first inserted into the grip 10 from the open end, with the first positioning member 11 locked with the second positioning member 21 and with the ribs 13 engaged with the slots 22 so that the lining 20 can be restrictively combined with grip 10. Next, the grip portion 31 of the pivotal tube 30 is inserted into the top end of the lining 20, with the second restriction member 32 engaged with the first restriction member 23. The pivotal tube 30 can rotate in the lining 20 because the outer diameter of the pivotal tube 30 is slightly smaller than the inner diameter of the lining 20, and the assembly of the applicator of a rolled strip is thus completed.

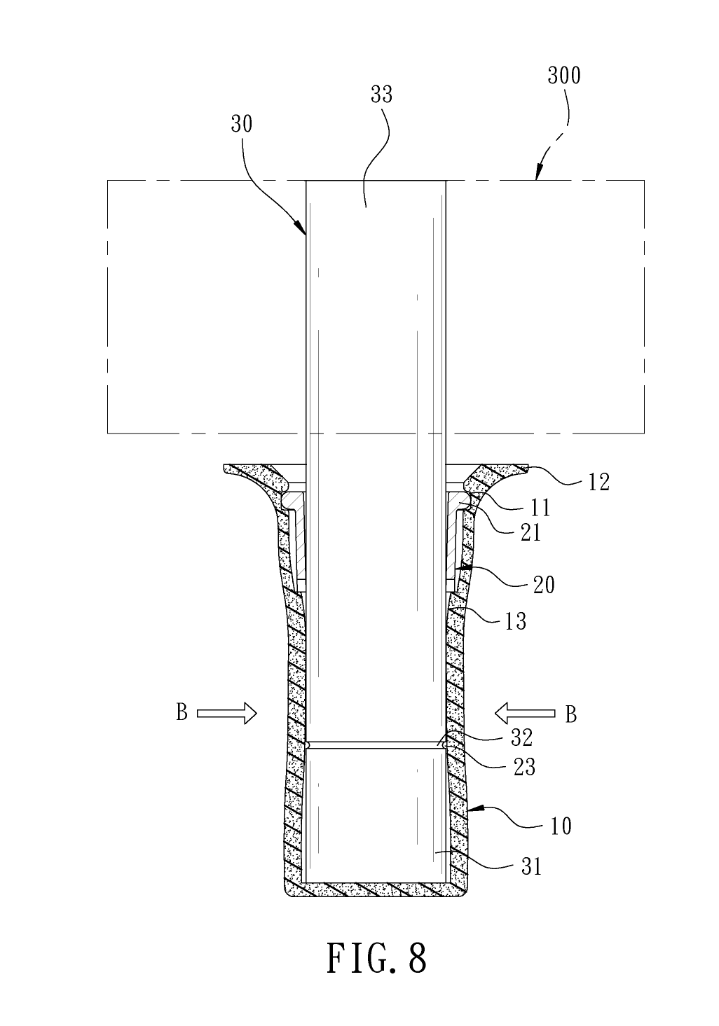

With reference to FIGS. 7 and 8, because the circular length of the second outer peripheral surface 211 of the second position member 21 of the lining 20 is greater the circular length of the inner peripheral surface 141 of the open end 14 of the grip 10, and also because the grip 10 is made of flexible material, the lining 20 may smoothly pass the open end 14 of the grip 10. Finally, the second positioning member 21 of the lining 20 will be firmed fitted in the first positioning member 11 of the grip 10. The lining 20 will stay firmly within the grip 10 during operation of the applicator for the rolled strip.

When user likes to use the applicator of the present invention, the tubular working member 33 of the pivotal tube 30 of the applicator 100 is first inserted in an axial hole of a rolled strip 300 and fitted firmly therein so that the strip generally as a film of the rolled strip 300 can be rewound along the application of the pivotal tube 30. When the rolled strip 300 is to be used to pack a commodity placed on top of a pellet, a user can hold the grip 10 to move the applicator around the goods and wrapped them in a desired direction. With the rotation of the pivotal tube 30, the film material of the rolled strip 300 can be smoothly released. In FIG. 8, when a radial force is properly applied along the arrow direction B, the grip 10 will be slightly deformed to squeeze the lining 20 to shrink its inner diameter. This will enable the ribs 13 of the grip 10 to contact on the outer wall of the pivotal tube 30 to restrain it from rotating. And the application of the film of the rolled strip 300 will be steadily stopped. By this way, user can keep on adjusting the radial force so as to adjusting the package tightness of the rolled strip 300. The rolled strip 300 can be unreeled again while the grip 10 is turned backward to release the radial force. Therefore, the rolled strip 300 can wrap up goods with sufficient tension by just commanding the grip 10.

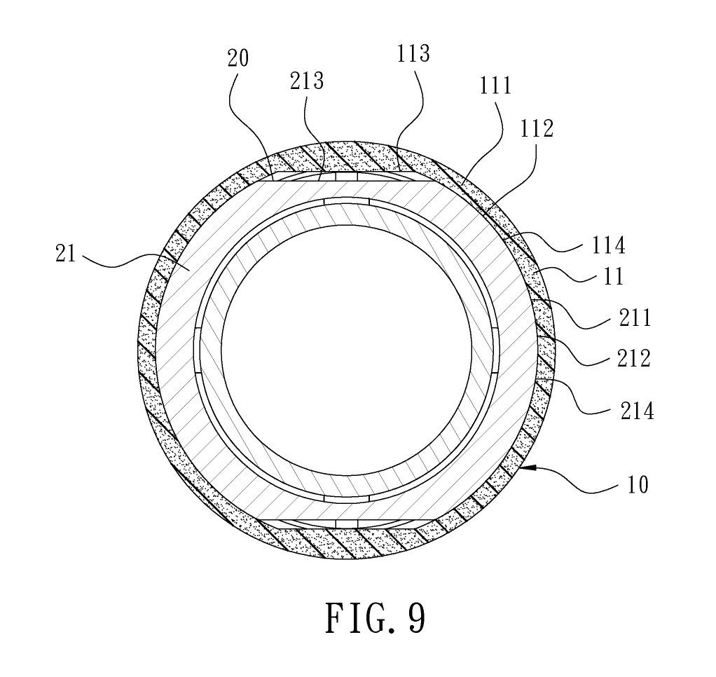

It is also to be noted that the first positioning member 11 is in a shape of non-circular restriction recess to form a first inner peripheral surface 111 consisting of a first surface 112 which can be either a first plan surface 113 or a first arced surface 114. Coincide with the first positioning member 11, the second positioning 21 has a second outer peripheral surface 211 which consists a plurality of second surface 212 which is either a second plan surface 213 or a second arced surface 214. One can easily understand the non-circular shape of the first positioning member 11 and the second positioning member 21 can be elliptical, polygonal, etc. With the combination of plan surface and arced surface as show in the embodiment of present invention, the first positioning member 11 of the grip 10 and the second positioning member 21 of the lining 20 can be firmly positioned together without corresponding sliding during the operation of the applicator, as shown in FIG. 9.

While the preferred embodiment of the applicator for a rolled strip according to the present invention has been described above, it will be recognized and understood that various modifications may be made therein and the appended claims are intended to cover all such modifications that may fall within the spirit and scope of the invention.

What is claimed is:

1. An applicator for a rolled strip comprising:
a grip made of a flexible material in a tubular shape with a sealed bottom end and an open top end, a first positioning member formed in an inner wall of said top end of said grip;
a lining in a tubular shape with inner wall and two open ends and being inserted in said grip, said lining comprising a second positioning member formed on an outer peripheral surface of said lining being coincide with said first positioning member of said grip, a plurality of slots axially provided in said lining, a first restriction member being provided on said inner wall of said lining; and
a pivotal tube having one end thereof being inserted in said lining, said pivotal tube comprising a second restriction member being coincide with said first restriction member of said lining, said pivotal tube having an outer diameter slightly smaller than an inner diameter of said lining,
whereby said pivotal tube being pivotally positioned in said lining and being able to be squeezed by said lining to stop rotation due to a radial force applied by a user holding said grip.

2. An applicator for a rolled strip as claimed in claim 1, wherein said first positioning member being a recess and said second restriction member being protrusion.

3. An applicator for a rolled strip as claimed in claim 2, wherein first positioning member being a recess in a non-circular shape and said second positioning member being a protrusion in a non-circular shape.

4. An applicator for a rolled strip as claimed in claim 1, wherein said first positioning member comprising an inner peripheral surface which consists a first plan surface and an arced surface; said second positioning member comprising an outer peripheral surface which consists a second plan surface and a second arced surface.

5. An applicator for a rolled strip as claimed in claim 1, wherein said first restriction member of said grip being an annular projections and said second restriction member of said lining being an annular groove.

6. An applicator for a rolled strip as claimed in claim 1, wherein said grip comprises a plurality of ribs formed axially on an inner wall thereof and being coincide with said slots of said lining.

7. An applicator for a rolled strip as claimed in claim 1, wherein said grip is provided with a flange horizontally extended outward from a top end of said grip.

8. An applicator for a rolled strip as claimed in claim 1, wherein each of said slots of said lining forming a free end at a bottom end thereof.

9. An applicator for a rolled strip as claimed in claim 1 wherein said second outer peripheral surface of said second positioning member has a circular length greater than the same of said first inner peripheral surface of said grip.
